(19) United States
(12) Patent Application Publication
(10) Pub. No.: US 2016/0273331 A1
(43) Pub. Date: Sep. 22, 2016

(54) Dynamic Determination of a Single Equivalent Circulating Density (ECD) Using Multiple ECDs Along a Wellbore

(71) Applicant: HALLIBURTON ENERGY SERVICES INC., Houston, TX (US)

(72) Inventors: Nancy S. Davis, Irving, TX (US); Cody N. Butler, Dallas, TX (US)

(21) Appl. No.: 15/033,525

(22) PCT Filed: Dec. 20, 2013
(86) PCT No.: PCT/US13/77208

§ 371 Date: Apr. 29, 2016

(51) Int. Cl. E21B 44/00; G05B 15/02; G05D 7/06; E21B 21/08; E21B 47/06

(52) U.S. Cl. CPC E21B 44/00; E21B 21/08; E21B 47/06; G05D 7/0635; G05B 15/02; E21B 2021/006

(57) ABSTRACT

A well drilling system and method to balance multiple equivalent circulating density (“ECD”) targets along a wellbore during drilling.

### FIELD OF THE DISCLOSURE

The present disclosure relates generally to systems and methods used in managed pressure drilling and, more specifically, to a system and method for balancing multiple Equivalent Circulation Density (“ECD”) target values simultaneously.

### BACKGROUND

In hydrocarbon exploration, it is important to manage wellbore pressure properly during drilling, to ensure that the drilling process leads to a stable hole. If there is too much fluid pressure during drilling, there may be insufficient margins between formation fracture and pore pressures, which may result in damage to the formation and production difficulties. If the pressure is low, however, a “blowout” can occur, resulting in at very dangerous environment which is expensive to cure.

At the same time, there is an incentive to drill as quickly as possible, because to do so saves time and thus expense. However, drilling faster makes it more difficult to properly respond to wellbore pressure changes. Thus, a challenge during drilling operations is determining a rate of penetration that is optimally fast, and yet safe.

Traditionally, managed pressure drilling has been used to manage wellbore pressures during drilling. Managed pressure drilling is the art of precisely controlling bottom hole pressure during drilling by using a closed annulus and a mechanism for regulating pressure in the annulus. Management of the pressure is accomplished with reference to the Equivalent Circulating Density (“ECD”), which reflects the pressure the mud places on the wellbore during drilling. In particular, the ECD factors in both the static weight of the fluid column and the additional pressure component induced by the circulating fluid. The equivalent circulating density of the circulating fluid is greater than the actual density of that fluid, so that the balance between formation pressure and pressure of the fluid column at a particular moment is affected by whether the fluid is being circulated at that moment. Typically, the ECD is controlled to a single target that maintains the desired pressure, which is then maintained along the wellbore during drilling.

However, this traditional approach to managed pressure drilling is not optimal because in certain reservoirs the range of appropriate ECD values differs at different depths along the wellbore. Also, during horizontal drilling, there are generally two points of interest—the shoe and the bit—which may have different ECD values.

Accordingly, there is a need in the art for an improved managed pressure drilling method which allows balancing of multiple ECD targets simultaneously.

### BRIEF DESCRIPTION OF THE DRAWINGS

FIG. 1 illustrates a well drilling system embodying principles of illustrative embodiments of the present disclosure;

FIG. 2 is a block diagram of a control system to control wellbore pressure in accordance with certain illustrative embodiments of the present disclosure; and

FIG. 3 is a flow chart of a method used to balance multiple target ECD values during drilling operations, according to certain illustrative methods of the present disclosure.

### DESCRIPTION OF ILLUSTRATIVE EMBODIMENTS

Illustrative embodiments and related methodologies of the present disclosure are described below as they might be employed in a system and method to balance multiple ECD targets simultaneously along a wellborn. In the interest of clarity, not all features of an actual implementation or methodology are described, in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of this disclosure will become apparent from consideration of the following description and drawings.

As described herein, illustrative embodiments and methods of the present disclosure determine and balance multiple ECD targets along a wellbore during drilling. In general, this is accomplished by first determining a plurality of control points along the wellbore and their associated pressures. Using their associated pressures, a target ECD value for each control point is then determined, thereby resulting in a set of target ECD values. Thereafter, an overall target ECD value for the entire wellbore is determined based upon the set of target ECD values, and the wellbore pressure is controlled accordingly during drilling. As a result, different target ECD values for different well sections can be balanced, thus enhancing the controllability of the wellbore and improving overall safety. The illustrative embodiments and methods described herein may also be applied to dual/multiple gradient drilling, as will be understood by those ordinarily skilled in the art having the benefit of this disclosure.

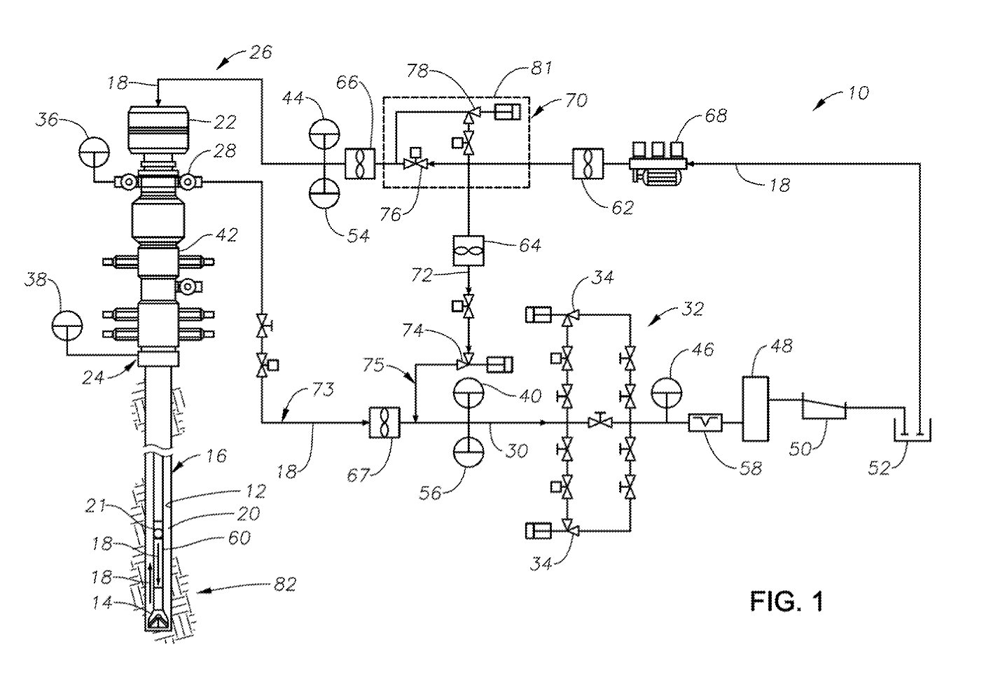

FIG. 1 illustrates a well drilling system embodying principles of illustrative embodiments of the present disclosure. In well drilling system 10, a wellbore 12 is drilled by rotating a drill bit 14 on an end of a drill string 16. Drilling fluid 18, commonly known as mud, is circulated downward through the drill string 16, out drill bit 14 and upward through an annulus 20 formed between the drill string and wellbore 12, in order to cool the drill bit, lubricate the drill string, remove cuttings and to assist with bottom hole pressure control. A non-return valve 21 (e.g., a flapper-type check valve) prevents flow of drilling fluid 18 upward through drill string 16 (e.g., when connections are being made in the drill string).

Control of bottom hole pressure is very important in managed pressure drilling, and in other types of drilling operations. Preferably, the bottom hole pressure is precisely controlled (using various pressure-regulating mechanisms are described below) to prevent excessive loss of fluid into earth formation 82 surrounding wellbore 12, undesired fracturing of the formation, undesired influx of formation fluids into the wellbore, etc. In managed pressure drilling, it is desired to maintain the bottom hole pressure just slightly greater than a pore pressure of the formation, without exceeding a fracture pressure of the formation. This technique is especially useful in situations where the margin between pore pressure and fracture pressure is relatively small.

In underbalanced drilling, it is desired to maintain the bottom hole pressure somewhat less than the pore pressure, thereby obtaining a controlled influx of fluid from the formation. In overbalanced drilling, it is desired to maintain the bottom hole pressure somewhat greater than the pore pressure, thereby preventing (or at least mitigating) influx of fluid from the formation. The annulus 20 can be open to the atmosphere at the surface during overbalanced drilling, and wellbore pressure is controlled during drilling by adjusting a density of drilling fluid 18. Nitrogen or another gas, or another lighter weight fluid, may be added to drilling fluid 18 for pressure control. This technique is useful, for example, in underbalanced drilling operations.

In well drilling system 10, additional control over the wellbore pressure is obtained by closing off annulus 20 (e.g., isolating, it from communication with the atmosphere and enabling the annulus to be pressurized at or near the surface) using a rotating control device 22 (“RCD”). The RCD 22 seals about drill string 16 above a wellhead 24. Although not shown in FIG. 1, drill string 16 would extend upwardly through RCD 22 for connection to, for example, a rotary table (not shown), a standpipe line 26, kelley (not shown), a top drive and/or other conventional drilling equipment.

In this illustrative embodiment, drilling fluid 18 exits wellhead 24 via a wing valve 28 in communication with annulus 20 below RCD 22. Drilling fluid 18 then flows through mud return lines 30, 73 to a choke manifold 32, which includes redundant chokes 34. Backpressure is applied to annulus 20 by variably restricting flow of drilling fluid 18 through the operative one(s) of the redundant choke(s) 34.

The greater the restriction to flow through the operative choke(s) 34, the greater the backpressure applied to annulus 20. Thus, downhole pressure (e.g., pressure at the bottom of wellbore 12, pressure at a downhole casing shoe, pressure at a particular control point as described below, formation or zone, etc.) can be regulated by varying the backpressure applied to annulus 20. In certain embodiments as described more fully below, a system control system, which embodies a hydraulics model, is used to select a plurality of control points along annulus 20, and to determine their associated pressures. The control system then utilizes the pressures to calculate target ECD values for each control point. Using the resulting set of ECD values, an overall target ECD value is determined. Thereafter, based upon the overall target ECD value, the control system determines the corresponding pressure to be applied to annulus 20 at or near the surface which will result in a desired downhole pressure during drilling.

In certain illustrative embodiments of well system 10, pressure applied to annulus 20 can be measured at or near the surface via a variety of pressure sensors 36, 38, 40, each of which is in communication with annulus 20. Pressure sensor 36 senses pressure below the RCD 22, but above a blowout preventer (“BOP”) stack 42. Pressure sensor 38 senses pressure in wellhead 24 below BOP stack 42. Pressure sensor 40 senses pressure in the mud return lines 30, 73 upstream of the choke manifold 32. Another pressure sensor 44 senses pressure in the standpipe line 26. Yet another pressure sensor 46 senses pressure downstream of choke manifold 32, but upstream of a separator 48, shaker 50 and mud pit 52. Additional sensors include temperature sensors 54, 56, Coriolis flowmeter 58, and flowmeters 62, 64, 66.

Not all of these sensors are necessary. For example, well drilling system 10 could include only two of the three flowmeters 62, 64, 66. However, input from all available sensors is useful to the hydraulics model in determining what the pressure applied to the annulus 20 should be during the drilling operation. Other sensor types may be used, if desired. For example, it is not necessary for the flowmeter 58 to be a Coriolis flowmeter, since a turbine flowmeter, acoustic flowmeter, or another type of flowmeter could be used instead.

In addition, drill string 16 may include its own sensors 60, for example, to directly measure downhole pressure. Such sensors 60 may be of the type known to those ordinarily skilled in the art as pressure while drilling (“PWD”), measurement while drilling (“MWD”) and/or logging while drilling (“LWD”). These drill string sensor systems generally provide at least pressure measurement, and may also provide temperature measurement, detection of drill string characteristics (such as vibration, weight on bit, stick-slip, etc.), formation characteristics (such as resistivity, density, etc.) and/or other measurements. Various forms of wired or wireless telemetry (acoustic, pressure pulse, electromagnetic, etc.) may be used to transmit the downhole sensor measurements to the surface. For example, lines (such as, electrical, optical, hydraulic, etc., lines) could be provided in a wall of drill string 16 for communicating power, data, commands, pressure, flow, etc.

In yet other illustrative embodiments, additional sensors could be included in the system 10, if desired. For example, another flowmeter 67 could be used to measure the rate of flow of fluid 18 exiting wellhead 24, another Coriolis flowmeter (not shown) could be interconnected directly upstream or downstream of a rig mud pump 68, etc. Alternatively, fewer sensors could be included in the system 10, if desired. For example, the output of the rig mud pump 68 could be determined by counting pump strokes, instead of by using the flowmeter 62 or any other flowmeters. Moreover, note that separator 48 could be a 3 or 4 phase separator, or a mud gas separator (sometimes referred to as a “poor boy degasser”). However, separator 48 is not necessarily used in the system 10.

Drilling fluid 18 is pumped through standpipe, line 26 and into the interior of drill string 16 by rig mud pump 68. The pump 68 receives fluid 18 from mud pit 52 and flows it via a standpipe manifold 70 to standpipe 26. Fluid 18 then circulates downward through drill string 16, upward through the annulus 20, through the mud return lines 30, 73, through the choke manifold 32, and then via separator 48 and shaker 50, to mud pit 52 for conditioning and recirculation.

Note that, in the illustrative well drilling system 10 as so far described above, choke 34 cannot be used to control backpressure applied to annulus 20 for control of the downhole pressure, unless fluid 18 is flowing through the choke. In conventional overbalanced drilling operations, a lack of fluid 18 flow will occur, for example, whenever a connection is made in drill string 16 (e.g., to add another length of drill pipe to the drill string as wellbore 12 is drilled deeper), and the lack of circulation will require that downhole pressure be regulated solely by the density of the fluid 18.

In well drilling system 10, however, flow of fluid 18 through choke 34 can be maintained, even though the fluid does not circulate through drill string 16 and annulus 20, while a connection is being made in the drill string. Thus, pressure can still be applied to annulus 20 by restricting flow of fluid 18 through choke 34, even though a separate backpressure pump may not be used. However, in other examples, a backpressure pump (not shown) could be used to supply pressure to annulus 20 while fluid 18 does not circulate through the drill string 16, if desired.

In the example of FIG. 1, when fluid 18 is not circulating through drill string 16 and annulus 20 (e.g., when a connection is made in the drill string), fluid 18 is flowed from pump 68 to the choke manifold 32 via a bypass line 72, 75. Thus, fluid 18 can bypass standpipe line 26, drill string 16 and annulus 20, and can flow directly from pump 68 to mud return line 30, which remains in communication with annulus 20. Restriction of this flow by choke 34 will thereby cause pressure to be applied to annulus 20 (for example, in typical managed pressure drilling).

As depicted in FIG. 1, both of bypass line 75 and mud return line 30 are in communication with annulus 20 via a single line 73. However, bypass line 75 and mud return line 30 could instead be separately connected to wellhead 24, for example, using an additional wing valve (e.g., below RCD 22), in which case each of the lines 30, 75 would be directly in communication with the annulus 20.

Although this might require additional piping at the rig site, the effect on the annulus pressure would be essentially the same as connecting, bypass line 75 and the mud return line 30 to common line 73. Thus, it should be appreciated that various different configurations of the components of system 10 may be used, without departing from the principles of this disclosure.

Flow of the fluid 18 through bypass line 72, 75 is regulated by a choke or other type of flow control device 74. Line 72 is upstream of bypass flow control device 74, and line 75 is downstream of the bypass flow control device. Flow of fluid 18 through the standpipe line 26 is substantially controlled by a valve or other type of flow control device 76. Note that flow control devices 74, 76 are independently controllable, which provides substantial benefits to the system 10, as described more fully below.

Since the rate of flow of fluid 18 through each of the standpipe and bypass lines 26, 72 is useful in determining how bottom hole pressure is affected by these flows, flowmeters 64, 66 are depicted in FIG. 1 as being interconnected in these lines. However, the rate of flow through standpipe line 26 could be determined even if only flowmeters 62, 64 were used, and the rate of flow through the bypass line 72 could be determined even if only flowmeters 62, 66 were used. Thus, it should be understood that it is not necessary for system 10 to include all of the sensors depicted in FIG. 1 and described herein, and the system could instead include additional sensors, different combinations and/or types of sensors, etc.

Still referring to the illustrative embodiment of FIG. 1, a bypass flow control device 78 may be used for filling standpipe line 26 and drill string 16 after a connection is made in the drill string, and for equalizing pressure between the standpipe line and mud return lines 30, 73 prior to opening flow control device 76. Otherwise, sudden opening of the flow control device 76 prior to standpipe line 26 and drill string 16 being filled and pressurized with fluid 18 could cause an undesirable pressure transient in annulus 20 (e.g., due to flow to the choke manifold 32 temporarily being lost while the standpipe line and drill string fill with fluid, etc.).

By opening standpipe bypass flow control device 78 after a connection is made, fluid 18 is permitted to fill standpipe line 26 and drill string 16 while a substantial majority of the fluid continues to flow through the bypass line 72, thereby enabling continued controlled application of pressure to annulus 20. After the pressure in standpipe line 26 has equalized with the pressure in mud return lines 30, 73 and bypass line 75, flow control device 76 can be opened, and then flow control device 74 can be closed to slowly divert a greater proportion of fluid 18 from bypass line 72 to standpipe line 26. Before a connection is made in drill string 16, a similar process can be performed, except in reverse, to gradually divert flow of fluid 18 from standpipe line 26 to bypass line 72 in preparation for adding more drill pipe to the drill string 16. That is, flow control device 74 can be gradually opened to slowly divert a greater proportion of fluid 18 from standpipe line 26 to the bypass line 72, and then the flow control device 76 can be closed.

Note that flow control devices 76, 78 could be integrated into a single flow control device 81 (e.g., a single choke which can gradually open to slowly fill and pressurize standpipe line 26 and drill string 16 after a drill pipe connection is made, and then open fully to allow maximum flow while drilling). However, since typical conventional drilling rigs are equipped with flow control device 76 in the form of a valve in standpipe manifold 70, and use of the standpipe valve is incorporated into usual drilling practices, the individually operable flow control devices 76, 78 are presently preferred.

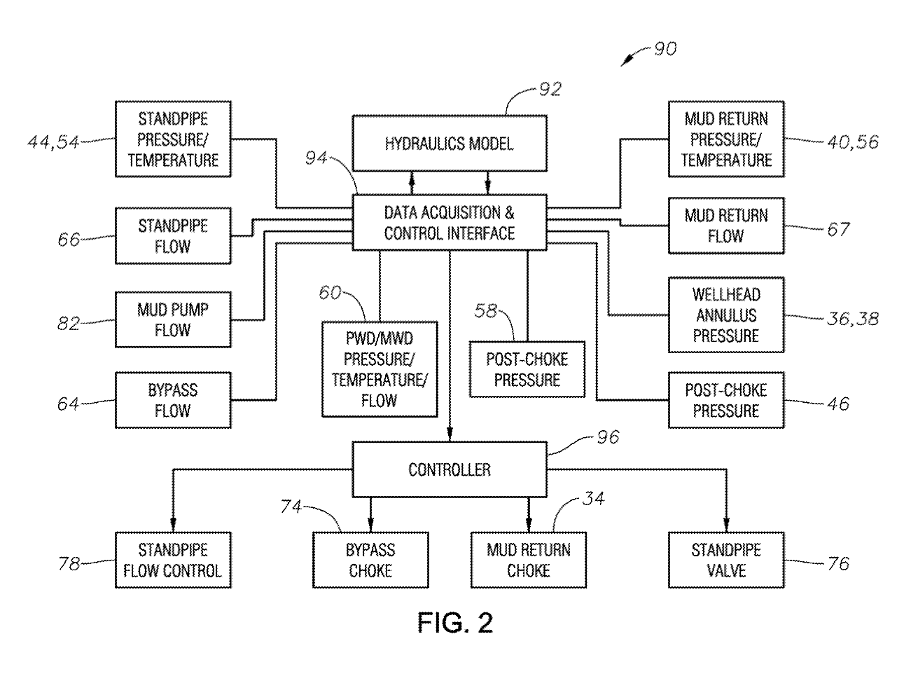

FIG. 2 is a block diagram of a control system utilizes to control wellbore pressure in accordance with certain illustrative embodiments of the present disclosure. Pressure and flow control system 90 is preferably fully automated, although some human intervention may be used, for example, to safeguard against improper operation, initiate certain routines, update parameters, etc. Control system 90 includes a hydraulics model 92, a data acquisition and control interface 94 and a controller 96 (such as a programmable logic controller or PLC, a suitably programmed computer, etc.). Although these elements 92, 94, 96 are depicted separately in FIG. 2, any or all of them could be combined into a single element, or the functions of the elements could be separated into additional elements, other additional elements and/or functions could be provided, etc.

Hydraulics model 92 is used in control system 90 to determine the desired annulus pressure at or near the surface to achieve the desired downhole pressure. Data such as well geometry, fluid properties and offset well information (such as geothermal gradient, pore pressure and fracture gradient, etc.) are used by hydraulics model 92 in making this determination, as well as real-time sensor data acquired by the data acquisition and control interface 94. Thus, there is a continual two-way transfer of data and information between hydraulics model 92 and data acquisition and control interface 94. It is important to appreciate that data acquisition and control interface 94 operate to maintain a substantially continuous flow of real-time data from the sensors 44, 54, 66, 62, 64, 60, 58, 46, 36, 38, 40, 56, 67 to hydraulics model 92, so that hydraulics model 92 has the information it needs to adapt to changing circumstances and to update the desired annulus pressure and ECD values, and the hydraulics model operates to supply the data acquisition and control interface substantially continuously with a value for the desired annulus pressure.

Illustrative hydraulics models for use as hydraulics model 92 in control system 90 are GBSetpoint™ or the hydraulics model produced by SINTEF of Trondheim, Norway. A variety of other hydraulics model may be used in control system 90 in keeping with the principles of this disclosure, as will be understood by those ordinarily skilled in the art having the benefit of this disclosure.

Illustrative data acquisition and control interfaces for use as data acquisition and control interface 94 are SENTRY™ and INSITE™, also provided by Halliburton Energy Services, Inc. Any suitable data acquisition and control interface may be used in the control system 90 in keeping with the principles of this disclosure. Controller 96 operates to maintain a desired annulus pressure by controlling operation of mud return choke 34. When an updated ECD value (and its corresponding annulus pressure) is transmitted from data acquisition and control interface 94 to controller 96, the controller uses the ECD value as a setpoint and controls operation of choke 34 in a manner (e.g., increasing or decreasing flow resistance through the choke as needed) to maintain the corresponding ECD pressure in annulus 20. The choke 34 can be closed more to increase flow resistance, or opened more to decrease flow resistance.

Control of the ECD setpoint pressure is accomplished by comparing the determined EDC value to a measured annulus pressure (such as the pressure sensed by any of the sensors 36, 38, 40), and decreasing flow resistance through the choke 34 if the measured pressure is greater than the ECD setpoint pressure, and increasing flow resistance through the choke if the measured pressure is less than the ECD setpoint pressure. Of course, if the ECD setpoint pressure and measured pressures are the same, then no adjustment of the choke 34 is required. This process is preferably automated, so that no human intervention is required, although human intervention may be used, if desired.

Controller 96 may also be used to control operation of the standpipe flow control devices 76, 78 and bypass flow control device 74. Controller 96 can, thus, be used to automate the processes of diverting flow of fluid 18 from standpipe line 26 to bypass line 72 prior to making a connection in drill string 16, then diverting flow from the bypass line to the standpipe line after the connection is made, and then resuming normal circulation of fluid 18 for drilling. Again, no human intervention may be required in these automated processes, although human intervention may be used if desired, for example, to initiate each process in turn, to manually operate a component of the system, etc.

Although not illustrated, control system 90 may also include a non-transitory, computer-readable storage, transceiver/network communication module, optional I/O devices, and a display (e.g., user interface), all interconnected via a system bus. Software instructions executable by the controller 96 for implementing software instructions in accordance with the exemplary embodiments described herein, may be stored in storage or some other computer-readable medium. It will be recognized that control system 90 may be connected to one or more public and/or private networks via one or more appropriate network connections. It will also be recognized that the software instructions embodying methods of the present disclosure may also be loaded into storage from a CD-ROM or other appropriate storage media via wired or wireless methods.

Moreover, those ordinarily skilled in the art will appreciate that embodiments of this disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. This disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof in a computer system or other processing system.

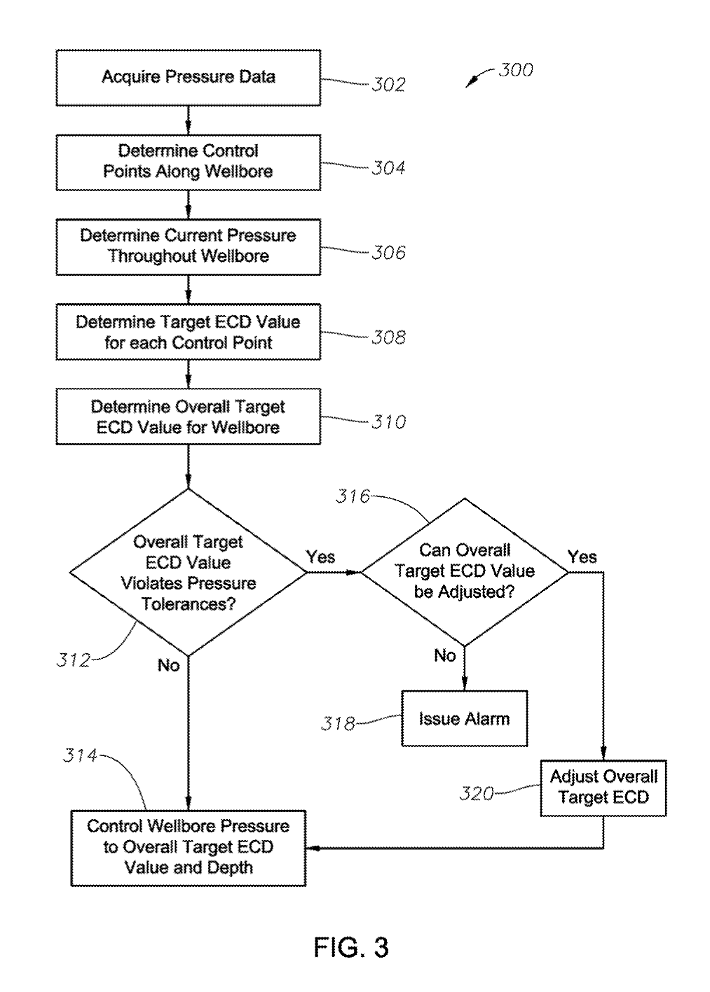

FIG. 3 is a flow chart of a method 300 used to balance multiple target ECD values during drilling operations, according to certain illustrative methods of the present disclosure. Method 300 may be performed in conjunction with well drilling system 10 described above, or it may be performed with other well systems. Thus, method 300 is not limited to any of the details of well drilling system 10 described herein or depicted in the drawings. Nevertheless, in block 302, method 300 begins while drilling ahead. Alternatively, however, method 300 may be performed before drilling operations begin. However, as illustrated, at block 302, control system 90 may receive real-time PWD data and/or surface data from one or more of the sensors described previously. At block 304, control system 90 determines a plurality of control points along wellbore 12 using hydraulics model 92. The control points are the points along wellbore 12 where control of the pressure is desired, as each control point has a different pressure. For example, one control point may be at the shoe and another at the bit, or at various desired depths along wellbore 12. As a result of the data received from hydraulics model 92, control system 90 determines the various pore and fracture pressures along wellbore 12, and selects control points accordingly. Each selected control point has a different weakness with regards to pore or facture pressure. As a result, each has a different ECD target.

Also at block 304, control system 90 determines the pressure type (pore or fracture) for each control point using the data from hydraulics model 92. In addition, using this same data, control system 90 determines the pressure tolerance of each control point, and the depth (true vertical depth or measured depth) along wellbore 12 of each control point. The pressure tolerance of each control point is a safety factor for the critical pressure. For example, if pore pressure is 300 PSI and a tolerance of 15 PSI then 315 would be the lowest allowable pressure. All of this data combined is then used by control system 90 as the control point. In certain embodiments, the critical pressure and location of the control points can be modified based on the real time data acquired at block 302, including LWD data (e.g., sonic gamma ray, porosity, etc.) that helps determine rock properties throughout the wellbore. Therefore, while drilling, the estimated fracture or pore pressure of the control point and its depth may be modified by the model based on the real time data.

At block 306, control system 90 determines the current pressure throughout annulus 20 of wellbore 12. Determination of the pressure(s) may be conducted using the pressure data received at block 302 (if method 300 were being conducted in real-time, for example). Alternatively, however, the pressure(s) may be determined using data received from hydraulics model 92, if method 300 were being performed before drilling operations began, for example.

At block 308, control system then determines the target ECD value for each control point based upon each control point's current pressure. As will be understood by those ordinarily skilled in the art having the benefit of this disclosure, ECD is the effective density exerted by a circulating fluid (the mud) against the formation that takes into account the pressure drop due to pressure differential between the borehole and the surface. ECD may be calculated from an annulus pressure (pressure of the circulating mud) measurement take at a selected position in the annulus based on the expression for hydrostatic pressure of a column of fluid:

p=ρgh Eq.(1),

where p represents the pressure, ρ represents the fluid density, g represents gravity, and h represents the vertical depth of the position (control point, for example) at which the pressure is measured. Solving the above expression for density provides the following expression for equivalent circulating density:

ECD=p/gh Eq.(2).

As described herein, the ECD may either be determined by the use of sensors, or modeled using hydraulics model 92. In any event, the ECD value reflects the pressure the mud places on the borehole during drilling. Accordingly, through use of the pore and fracture pressure data (real-time or static modeled data), control system determines target ECD values for each control point, thus resulting in a set of target ECD values at block 308.

At block 310, based upon the set of target ECD values, control system 90 determines an overall target ECD value for the entire wellbore. In certain illustrative embodiments, determination of the overall target ECD value is accomplished using a best fitting algorithm. Such algorithms are known in the art. Here, each control point (and, thus, their corresponding target ECD values) is analyzed using the fitting algorithm to thereby determine the best overall target ECD value and depth that “fits” for the entire wellbore.

At block 312, control system 90 then determines whether the overall target ECD value violates the pressure tolerances (e.g., pore and/or fracture pressures) of any of the control points determined above. If there is no violation, the algorithm moves onto block 314 where control system 90 controls/maintains the wellbore pressure to the overall target ECD value and depth. Here, as described above, control system 90 uses the overall target ECD value as the annulus setpoint pressure, and maintains or adjusts the annulus pressure accordingly.

However, if at block 312 control system 90 determines that the overall target ECD value violates the pressure tolerances, it then determines whether the overall target ECD value can be adjusted at block 316. Here, for example, control system 90 will determine if it is possible to avoid a fracture. If no adjustment can be made to avoid the fracture, an alarm is issued at block 318 such as, for example, an audible or visual alarm. If the adjustment can be made, however, control system 90 will adjust the overall target ECD at block 320 accordingly, and proceed to block 314 as previously described.

As previously described, method 300 may be applied to single, dual or multiple gradient wellbores. As will be understood by those ordinarily skilled nelsons mentioned herein, if more than one gradient is used, some physical separation of the gradients will be necessary to maintain the pressures. Moreover, the control points may be static or they may change dynamically during drilling, based upon real-time PWD data received from downhole sensors. Also, during the drilling operation, PWD data may be communicated continuously or intermittingly. Thus, illustrative embodiments of the present disclosure may be applied before or during drilling operations in real-time.

The exemplary embodiments described herein further relate to any one or more of the following paragraphs:

1. A well drilling method, comprising determining a plurality of control points along a wellbore; determining a current pressure throughout the wellbore; determining a target equivalent circulating density (“ECD”) value for each control point based upon the current pressure, thus resulting in a set of target ECD values; determining an overall target ECD value for the wellbore based upon the set of target ECD values; and controlling wellbore pressure based upon the overall target ECD value during drilling operations.
2. A method as defined in paragraph 1, wherein determining the plurality of control points comprises determining a pressure type for each control point; determining a pressure tolerance of each control point; and determining a depth for each control point, wherein the pressure type, pressure tolerance, and depth form the control point.
3. A method as defined in any of paragraphs 1 or 2, wherein the pressure type is a pore or fracture pressure.
4. A method as defined in any of paragraphs 1-3, wherein determining the overall target ECD value comprises applying a fitting algorithm to the control points in order to determine the overall target ECD.
5. A method as defined in any of paragraphs 1-4, wherein determining the overall target ECD value comprises determining if the overall target ECD value violates the pressure tolerance of any of the control points; and if the overall target ECD value violates the pressure tolerance, determining whether the overall target ECD value can be adjusted.
6. A method as defined in any of paragraphs 1-5, further comprising issuing an alarm if the overall target ECD value cannot be adjusted; or making the adjustment to thereby maintain the overall target ECD value if the overall target ECD value can be adjusted.
7. A method as defined in any of paragraphs 1-6, wherein the wellbore is single or dual gradient.
8. A method as defined in any of paragraphs 1-7, wherein the drilling operation comprises a measurement-while-drilling or logging-while-drilling operation.
9. A well drilling method, comprising determining a plurality of control points along a wellbore; determining a target equivalent circulating density (“ECD”) value for the wellbore based upon the control points; and controlling wellbore pressure based upon the target ECD value during drilling operations.
10. A method as defined in paragraph 9, wherein determining the plurality of control points comprises determining a pressure type for each control point; determining a pressure tolerance of each control point; and determining a depth for each control point, wherein the pressure type, pressure tolerance, and depth form the control point.
11. A method as defined in any of paragraphs 9-10, wherein determining the target ECD comprises: determining if the target ECD value violates the pressure tolerance of any of the control points; and if the target ECD value violates the pressure tolerance, determining whether the target ECD value can be adjusted.
12. A method as defined in any of paragraphs 9-11, further comprising issuing an alarm if the target ECD value cannot be adjusted; or making the adjustment to thereby maintain the target ECD value if the target ECD value can be adjusted.
13. A method as defined in in any of paragraphs 9-12, wherein the drilling operation includes measurement-while-drilling or logging-while-drilling.
14. A well drilling system, comprising a drill string having a bit to drill a wellbore; a pressure-regulating mechanism to control bottom hole pressure of the wellbore; sensors to sense pressures at various points along the well drilling system; and a control system communicably coupled to the pressure-regulating mechanism and the sensors to thereby control the bottom hole pressure, the control system comprising processing circuitry to implement a method comprising determining a plurality of control points along the wellborn; determining a current pressure throughout the wellbore; determining a target equivalent circulating density (“ECD”) value for each control point based upon the current pressure, thus resulting in a set of target ECD values; determining an overall target ECD value for the wellbore based upon the set of target ECD values; and controlling wellbore pressure based upon the overall target ECD value during drilling operations.
15. A system as defined in paragraph 14, wherein determining the plurality of control points comprises determining a pressure type for each control point; determining a pressure tolerance of each control point; and determining a depth for each control point, wherein the pressure type, pressure tolerance, and depth form the control point.
16. A system as defined in any of paragraphs 14-15, wherein the pressure type is a pore or fracture pressure.
17. A system as defined in any of paragraphs 14-16, wherein determining the overall target ECD value comprises applying a fitting algorithm to the control points in order to determine the overall target ECD.
18. A system as defined in any of paragraphs 14-17, wherein determining the overall target ECD value comprises determining if the overall target ECD value violates the pressure tolerance of any of the control points; and if the overall target ECD value violates the pressure tolerance, determining whether the overall target ECD value can be adjusted.
19. A system as defined in any of paragraphs 14-18, further comprising issuing an alarm if the overall target ECD value cannot be adjusted; or making the adjustment to thereby maintain the overall target ECD value if the overall target ECD value can be adjusted.
20. A system as defined in any of paragraphs 14-19, wherein the wellbore is single or dual gradient.
21. A system as defined in any of paragraphs 14-20, wherein the system is a measurement-while-drilling or logging-while-drilling system.

Furthermore, the exemplary methodologies described herein may be implemented by a system including processing circuitry or a computer program product including instructions which, when executed by at least one processor, causes the processor to perform any of the methodology described herein.

Although various embodiments and methodologies have been shown and described, the present disclosure is not limited to such embodiments and methodologies and will be understood to include all modifications and variations as would be apparent to one skilled in the art. Therefore, it should be understood that this disclosure is not intended to be limited to the particular forms disclosed. Rather, the intention is to cover all modifications, equivalents and alternatives falling within the spirit and scope of the disclosure as defined by the appended claims.

What is claimed is:

1. A well drilling method, comprising:
determining a plurality of control points along a wellbore;
determining a current pressure throughout the wellbore;
determining a target equivalent circulating density (“ECD”) value for each control point based upon the current pressure, thus resulting in a set of target ECD values;
determining, an overall target ECD value for the wellbore based upon the set of target ECD values; and
controlling wellbore pressure based upon the overall target ECD value during drilling operations.

2. A method as defined in claim 1, wherein determining the plurality of control points comprises:
determining a pressure type for each control point;
determining a pressure tolerance of each control point; and
determining a depth for each control point,
wherein the pressure type, pressure tolerance, and depth form the control point.

3. A method as defined in claim 2, wherein the pressure type is a pore or fracture pressure.

4. A method as defined in claim 1, wherein determining the overall target ECD value comprises applying a fitting algorithm to the control points in order to determine the overall target ECD.

5. A method as defined in claim 2, wherein determining the overall target ECD value comprises:
determining if the overall target ECD value violates the pressure tolerance of any of the control points; and
if the overall target ECD value violates the pressure tolerance, determining whether the overall target ECD value can be adjusted.

6. A method as defined in claim 5, further comprising:
issuing an alarm if the overall target ECD value cannot be adjusted; or
making the adjustment to thereby maintain the overall target ECD value if the overall target ECD value can be adjusted.

7. A method as defined in claim 1, wherein the wellbore is single or dual gradient.

8. A method as defined in claim 1, wherein the drilling operation comprises a measurement-while-drilling or logging-while-drilling operation.

9. A well drilling method, comprising:
determining a plurality of control points along a wellbore;
determining a target equivalent circulating density (“ECD”) value for the wellbore based upon the control points; and
controlling wellbore pressure based upon the target ECD value during drilling operations.

10. A method as defined in claim 9, wherein determining the plurality of control points comprises:
determining a pressure type for each control point;
determining a pressure tolerance of each control point; and
determining a depth for each control point,
wherein the pressure type, pressure tolerance, and depth form the control point.

11. A method as defined in claim 10, wherein determining the target ECD comprises:
determining if the target ECD value violates the pressure tolerance of any of the control points; and
if the target ECD value violates the pressure tolerance, determining whether the target ECD value can be adjusted.

12. A method as defined in claim 11, further comprising:
issuing an alarm if the target ECD value cannot be adjusted; or
making the adjustment to thereby maintain the target ECD value if the target ECD value can be adjusted.

13. A method as defined in claim 9, wherein the drilling operation includes measurement-while-drilling or logging-while-drilling.

14. A well drilling system, comprising:
a drill string having a bit to drill a wellbore;
a pressure-regulating mechanism to control bottom hole pressure of the wellbore;
sensors to sense pressures at various points along the well drilling system; and
a control system communicably coupled to the pressure-regulating mechanism and the sensors to thereby control the bottom hole pressure, the control system comprising processing circuitry to implement a method comprising:
determining a plurality of control points along the wellbore;
determining a current pressure throughout the wellbore;
determining a target equivalent circulating density (“ECD”) value for each control point based upon the current pressure, thus resulting in a set of target ECD values;
determining an overall target ECD value for the wellbore based upon the set of target ECD values; and
controlling wellbore pressure based upon the overall target ECD value during drilling operations.

15. A system as defined in claim 14, wherein determining the plurality of control points comprises:
determining a pressure type for each control point;
determining a pressure tolerance of each control point:
determining a depth for each control point,
wherein the pressure type, pressure tolerance, and depth form the control point.

16. A system as defined in claim 15, wherein the pressure type is a pore or fracture pressure.

17. A system as defined in claim 14, wherein determining the overall target ECD value comprises applying a fitting algorithm to the control points in order to determine the overall target ECD.

18. A system as defined in claim 15, wherein determining the overall target ECD value comprises:
determining if the overall target ECD value violates the pressure tolerance of any of the control points; and
if the overall target ECD value violates the pressure tolerance, determining whether the overall target ECD value can be adjusted.

19. A system as defined in claim 18, further comprising:
issuing an alarm if the overall target ECD value cannot be adjusted; or
making the adjustment to thereby maintain the overall target ECD value if the overall target ECD value can be adjusted.

20. A system as defined in claim 14, wherein the wellbore is single or dual gradient.

21. A system as defined in claim 14, wherein the system is a measurement-while-drilling or logging-while-drilling system.
